(19) United States
(12) Patent Application Publication
(10) Pub. No.: US 2021/0139635 A1
(43) Pub. Date: May 13, 2021

(54) SUPERABSORBENT POLYMER FOR POLYURETHANE FOAMS

(71) Applicant: 3M INNOVATIVE PROPERTIES COMPANY, St. Paul, MN (US)

(72) Inventors: Deborah C. Nascimento, Sao Paulo (BR); Nelson R. Costa, Sao Paulo (BR); Joao R. Talamoni, Sao Paulo (BR); Jose C. Grippo, Sao Paulo (BR)

(21) Appl. No.: 16/969,337

(22) PCT Filed: Feb. 4, 2019
(86) PCT No.: PCT/IB2019/050885

§ 371 Date: Aug. 12, 2020

Related U.S. Application Data
(60) Provisional application No. 62/631,078, filed on Feb. 15, 2018.

(51) Int. Cl. C08G 18/72; C08G 18/76; C08G 18/66; C08G 18/62; C08G 18/48; C08G 18/40; C08G 18/32; C08J 9/12

(52) U.S. Cl. CPC C08G 18/721; C08G 18/7621; C08G 18/6681; C08G 18/6266; C08G 18/6245; C08J 2375/08; C08G 18/4063; C08G 18/3275; C08J 9/125; C08J 2203/10; C08G 18/4829

(57) ABSTRACT

The present invention is a hydrophilic polyurethane end-capped with a superabsorbent polymer.

### FIELD OF THE INVENTION

The present invention is related to the field of polyurethanes. In particular, the present invention is a polyurethane foam with superabsorbent polymer end caps.

### BACKGROUND

Current sponges, such as the 3M Scotch-Brite® brand dishwashing sponge, are either composed of a material including cellulose derivatives or polyurethane foam. Polyurethanes are a well-established class of high performance polymers, which can be readily tailored to display unique combinations of tensile strength, toughness, and flexibility. As a good result of this versatility, polyurethanes have found utility in a variety of applications, including binder resins, abrasion resistant coatings, protective coatings, and membranes.

Aqueous polyurethane dispersions are broadly utilized when high performance polyurethane properties are required, but where volatile organic chemicals are not desirable. They offer advantages in that they have reduced volatile organic compound (VOC) emissions, they may eliminate exposure to toxic isocyanate or diamine compounds during coating, and they provide simplified overall processing. Aqueous polyurethane dispersions have been developed commercially as a means to deliver polyurethane coatings to a wide variety of substrates, including, for example, fibers, textiles, paper, films, wood, and concrete.

While polyurethane foam is extremely versatile, they can have limited surface hydrophilic properties. Additional components, such as superabsorbent polymers (SAPs) can be added to the polyurethane foam to increase the hydrophilic properties of the foam. SAPs are materials that have the ability to absorb and retain large volumes of water and aqueous solutions. This makes them ideal for use in a variety of water absorbing applications, such as baby diapers, adult incontinence pads, absorbent medical dressings, and controlled release mediums. Superabsorbent polymers are currently made from partially neutralized, lightly cross-linked poly (acrylic acid), which has been proven to give the best performance versus cost ratio. The polymers are manufactured at low solids levels for both quality and economic reasons and are dried and milled into granular white solids. When exposed to water or other aqueous solutions, the SAPs swell to a rubbery gel. In some cases, the SAP rubbery gel can include up to about 99% water.

In addition to being used for household cleaning, hydrophilic foams are also particularly suitable for wound management. They are able to protect wounds from drying out, to absorb wound discharge, to act as matrix for active substances of every type, and to act as basis for colonization with autologous or heterologous skin cells.

### SUMMARY

In one embodiment, the present invention is a hydrophilic polyurethane end-capped with a superabsorbent polymer.

In another embodiment, the present invention is a method of forming a polyurethane having a superabsorbent polymer in a backbone of the polyurethane. The method includes providing the superabsorbent polymer as a pre-polymer, mixing the pre-polymer with polyol to form a blend, and mixing the blend with diisocyanate.

In another embodiment, the present invention is a method of forming a polyurethane foam having a practical water absorption of at least about 40%. The method includes providing a pre-polymer, mixing the pre-polymer with polyol to form a blend, and mixing the blend with diisocyanate. The pre-polymer includes a first monomer with a group reactive with isocyanate and a second monomer having high water absorbency. The first and second monomers have double bonds.

### DETAILED DESCRIPTION

The present invention is a hydrophilic polyurethane end-capped with superabsorbent polymer, its method, and a polyurethane foam having increased hydrophilicity and water absorption properties. The polyurethane based hydrophilic foam is formed from basic raw materials with functional groups located within the polymer backbone. The functional groups include a superabsorbent polymer (SAP). The resulting polyurethane based hydrophilic foam can be a raw material used to produce, for example, sponges and dishwashing pads.

Super absorbent polymers (SAPs) have four mechanisms of action: capillarity, osmotic pressure difference between the polymer backbone and the medium (liquid), electromagnetic repulsion (negative charges and the COOH⁻ radical, which provides polymer elongation), and electromagnetic attraction based on ion-dipole interaction. Generally speaking, the high absorption rate of superabsorbent polymers is due to the osmotic pressure caused by sodium (Na⁺) or potassium (K⁺) salts, as well as the interactions with the COOH⁻ radical (attraction of positive charges and repulsion of negative charges) and the capillarity of its three-dimensional structure. Upon contact with water, the sodium or potassium ions are hydrated, reducing their attraction to the carboxylate ions (due to the high dielectric constant of water). This allows the sodium or potassium ions to move freely within the network, contributing to the osmotic pressure within the polymer. The mobile positive sodium or potassium ions, however, cannot leave the polymer because they are still weakly attracted to the negative carboxylate ions along the polymer backbone and so behave like they are trapped by a semi-permeable membrane. Therefore, the driving force for swelling is the difference between the osmotic pressure inside and outside the polymer. By increasing the level of sodium or potassium outside of the polymer, it will lower the osmotic pressure and reduce the swelling capacity of the polymer. The maximum swelling of the polymer will occur in deionized water.

In the present invention, the SAP is within the backbone of the polyurethane, or part of the molecular structure of the polymer, to maximize the hydrophilic properties of the resulting foam. If the SAP is within the polyurethane backbone, then the chemical bond that results from the chemical reaction between the reactive group of the SAP monomer with the NCO content of the isocyanate avoids the SAP to be washed out over time with water (i.e., the chemical bond avoids the SAP to be leached out of the product along use). With a crosslinked powder SAP and/or filler SAP, because they are not reactive with the isocyanate, it is not incorporated into the molecule, facilitating its leaching over time. The SAP includes a first monomer and a second monomer. Both monomers have double bonds. The first monomer has a group that is reactive with isocyanate. In one embodiment, the first monomer includes a hydroxy or amine group to react with isocyanate. The second monomer has high water absorbency. In one embodiment, the second monomer includes a carboxylate group with potassium or sodium salt.

In one embodiment, the first monomer includes acrylamide and the second monomer includes one of sodium acrylate or potassium acrylate. The acrylamide has a reactive amine group that reacts with the NCO group of diisocyanate, acting as a crosslinker to the polyurethane molecule. The acrylamide therefore incorporates the SAP into the polyurethane foam backbone. The sodium acrylate or potassium acrylate has a carboxylate group for interacting with water and promoting water absorbency. Because both monomers have double bonds, they can go through an addition reaction. To synthesize the SAP, the first and second monomer undergo free radical polymerization without a crosslinker.

[chemical structure]

In practice, the SAP is made prior to the foam formation and in a separate reaction (with the temperature and molecular weight control) as a pre-polymer. By forming the SAP pre-polymer prior to forming the foam, various parameters can be controlled, such as the final SAP molecule (size and copolymerization), the addition polymerization reaction temperature, and the influence of initiators (used for the carbon-carbon double bond addition reaction) in the NCO-terminated polymer. Consequently, making the SAP prior to and in a separate reaction from the foam results in better control of the final molecular weight of the SAP. The SAP molecular weight should not be too high in order to allow lower viscosity, which is prone to mixing and reacting with the NCO-terminated pre-polymer. Additionally, by avoiding the use of a crosslinker, the reaction between the first and second monomers result in a linear, low molecular weight SAP.

In one embodiment, to make the SAP, the first and second monomers are first mixed with deionized water at about 35° C. and 150 rpm for about 30 minutes. Initiators are then added and the mixing speed is reduced to 100 rpm. When the reaction starts (exothermic process), the temperature is raised to about 60° C. and the mixing speed is raised to 150 rpm until the reaction ends. The reaction temperature must be carried out at about 60° C., with a maximum temperature of about 65° C. in order to avoid monomers/polymer degradation. By adding the components in this order and at these parameters, the reactants (in the absence of crosslinker) the final molecular weight can be controlled by controlling the temperature. In one embodiment, the final Brookfield viscosity range is between about 20,000 and about 22,000 cps.

The SAP pre-polymer having isocyanate groups is then mixed and reacted with polyol, excess isocyanate, and a blowing agent. The polyol can be, for example, polyol-polyether, polyol-polyester, etc. In one embodiment, the blowing agent is water or other hydrocarbon with low molecular weight. In a second step, the pre-polymer SAP is mixed with the components that form the foam. For example, the pre-polymer is then mixed with polyol to form a blend. In a third step, this blend is mixed with diisocyanate to produce a polyurethane capped with SAP.

[chemical structure]

Various other materials can be added for special purposes, including, but not limited to: catalysts, surfactants, blowing agents, pigments, flame retardants, inorganic fillers, (such as glass fibers, glass powder, glass bubbles, silica, talc, calcium carbonate, kaolin, carbon black, ceramic fibers, carbon fibers, graphene, graphite), organic fillers (such as starch particles, wood powder, cotton fibers, cellulosic fibers), UV stabilizers, antioxidants, plasticizers, anti-static agents, fluorescent whitening agents, biostabilizers, biocides, and anti-fungal agents. Particularly, when added, the catalyst increases the reaction speed. Examples of suitable catalysts include, but are not limited to those described in U.S. Pat. No. 9,228,047, which is herein incorporated by reference. Surfactants are suitable to stabilize the foam cell. Additional blowing agents can be used to create expansion of the foam cell. Exemplary composition ranges for the final polyurethane foam is as follows:

| | Lower Limit | Experimental | Upper Limit |
|---|---|---|---|
| Components | (php) | (php) | (php) |
| 65% TDI Voranate T80, 35% | 95 | 110 | 130 |
| Voranol 3010 (Pre-polymer) | | | |
| Voranol 3010 (Polyol) | 100 | 94.50 | 90 |
| Voranol 1421 (Polyol) | 0 | 5.50 | 10 |
| Superabsorbent Polymer | 0.50 | 0.90 | 1.50 |
| (SAP) | | | |
| Water (Blowing agent) | 2.50 | 5.00 | 7.00 |
| Tegocolor Yellow (Pigment) | 0 | 1.00 | 2.00 |
| Tegostab B 8228 (Silicon | 0.30 | 0.75 | 1.50 |
| surfactant) | | | |
| Dabco BL17 (Blowing | 0 | 0.60 | 0.80 |
| catalyst) | | | |
| Dabco DEOA (Crosslinker) | 0 | 0.50 | 0.75 |
| KOSMOS 29 (Tin 2-Ethyl- | 0.05 | 0.40 | 0.80 |
| hexanoate) (Gel catalyst) | | | |
| Tegoamin AS33 (Gel | 0.02 | 0.10 | 0.40 |
| catalyst) | | | |

The end product is a polyurethane foam that includes SAP in its backbone, resulting in increased hydrophilicity and water absorption. In one embodiment, the polyurethane end-capped with SAP has a practical water absorption of at least about 40%, particularly at least about 60%, and more particularly at least about 75%.

Although the present invention has been described with reference to preferred embodiments, workers skilled in the art will recognize that changes may be made in form and detail without departing from the spirit and scope of the invention.

### EXAMPLES

The present invention is more particularly described in the following examples that are intended as illustrations only, since numerous modifications and variations within the scope of the present invention will be apparent to those skilled in the art. Unless otherwise noted, all parts, percentages, and ratios reported in the following examples are on a weight basis.

### Materials

| Trade name | Material Description | Source/Supplier |
|---|---|---|
| Acrylic acid | Monomer | BASF, Camaçari, BA, Brazil |
| Sodium Acrylate | Monomer | Sigma Aldrich, São Paulo, SP, Brazil |
| Potassium Carbonate | Salt | Sigma Aldrich, São Paulo, SP, Brazil |
| Acrylamide | Monomer | Mytech Inc., Burlington, NC, USA |
| Ferrous sulfate | Initiator | Synth, Diadema, SP, Brazil |
| Potassium persulfate | Initiator | Synth, Diadema, SP, Brazil |
| Sodium metabisulfite | Initiator | Synth, Diadema, SP, Brazil |
| Deionized water | Solvent | 3M made, Sumaré, SP, Brazil |
| TDI Voranate T80 | Diisocyanate | BASF, Mauá, SP, Brazil |
| Voranol 3010 | Polyol | Dow, Guarujá, SP, Brazil |
| 65% Voranate T80, | Pre-polymer system | 3M made, Itapetininga, SP, Brazil |
| 35% Voranol 3010 | | |
| Voranol 1421 | Polyol | Dow, Guarujá, SP, Brazil |
| Tegoamin AS33 | Amine (Gel catalyst) | Evonik, Guarulhos, SP, Brazil |
| KOSMOS 29 | Tin 2-Ethylhexanoate | Miracema Nuodex IND QUIM LTDA, |
| | (Gel catalyst) | Guarulhos, SP, Brazil |
| DABCO DEOA L | Crosslinker | Air Products and Chemicals, Inc., |
| | | Guarulhos, SP, Brazil |
| TEGOSTAB 8228 | Silicon Surfactant | Evonik, Guarulhos, SP, Brazil |
| DABCO BL-17 Catalyst | Delayed-action tertiary amine | Air Products and Chemicals, Inc., |
| | (Blowing catalyst) | Guarulhos, SP, Brazil |
| TEGOCOLOR Yellow | Pigment | Evonik, Guarulhos, SP, Brazil |
| Conventional Polyurethane Foam | Hydrophobic | Sanko, Diadema, SP, Brazil |
| (Comparative Example) | | CBP, Montemor, SP, Brazil |

### Test Methods

Practical Absorption Test (Water is Wiped with the Foam)

The foam of the present invention and the comparative example foam were cut into sizes of 11 cm (width)×8 cm (length)×2 cm (thickness). The dried samples were weighted. A total of 5 mL of cold tap water was measured with a beaker and poured onto a clean and dry surface (Post-it® Dry Erase Surface, a polyester film with a hard coating). Each sample was passed in a single continuous movement by hand over the water spilled on the surface. The sample passageway was about 50 cm, with an average passage speed of about 14 cm/s (minimum of 12 cm/s and maximum of 16 cm/s), and with a maximum deformation of the foam (considering manual pressure) of about 20%. The water was poured onto an area smaller than the base area of the foam. Each sample was weighed with its dry base (opposite to that passed on the surface) on the scale plate. The result was given in percentage by the ratio of water absorbed to total water added.

Capillarity Over Time Test (Natural Absorption of Water from a Surface)

The foam of the invention and the comparative foam were cut into sizes of 3 cm (width)×18 cm (length)×2 cm (thickness). Each foam sample was graduated from cm to cm from base to top along 18 cm length. A solution of cold tap water and bromocresol green dye was made by adding a spatula tip of dye to 500 mL of cold tap water in 600 mL glass beaker. A ring stand was set up so that a horizontal bar could hold the weight of the sample and a paperclip was bend around the horizontal bar so that act as hanger for the sample. The sample was attached and hanged from the ring stand horizontal bar using the paperclips, one paperclip per sample, so that it could hang downward without any significant disturbance. Sample was lowered to the surface of the colorful solution contained in the beaker, taking care not to immerse the material into the solution (but softly touching the sample base in test liquid surface). After touching the liquid, the stopwatch was started and the solution migrated by capillarity in the sample for several minutes. The result can be qualitative (if liquid migrated or not in the sample over time) or quantitative (given by the liquid height that migrated in the sample over time).

### Air Flow Test (Measures Cell Opening)

The foam of the invention and the comparative foam were cut into sizes of 10 cm (width)×10 cm (length)×2 cm (thickness), and the air flow was measured by using a foam air flow equipment, obtained from MAQTEST (Franca, Sao Paulo, Brazil). The result is given in cm³/s. The method is based in Brazilian standard NBR 8517.

### Density Test

The foam of the invention and the comparative foam were cut into sizes of 10 cm (width)×10 cm (length)×2 cm (thickness) and weighted. Density was calculated by the ratio of accurate weight to volume (which means multiplying width, length and thickness).

### Example 1

A superabsorbent polymer of the present invention was prepared as follows. About 250 mL of deionized water, about 26.7 grams of Acrylamide, and about 35.3 grams of Sodium Acrylate was added into a 1000 mL four-neck glass reactor. The proportion between Acrylamide and Sodium Acrylate was 1:1 so that a final theoretical solids percentage was of 20% (g/g). The contents were weighted out to the nearest 0.01 grams directly into the reactor and mixed using an overhead stirrer (EUROSTAR 60 digital, obtained from IKA), for 30 minutes at 120 rpm or until solution was completely homogenous. After complete homogenization, a group of initiators was added (0.075 grams ferrous sulphate, 1.000 grams potassium persulfate and 0.325 grams sodium metabisulfite), since reaction was made by free radical polymerization. No crosslinker was added. The system was mixed using the same mixing apparatus above (EUROSTAR 60 digital, obtained from IKA) at 120 rpm and slightly heated to 35° C. until reaction ended. The exothermic reaction occurred within minutes. The final product was a viscous gel with 20% solids g/g (both theoretical and measured, indicating that total reaction occurred between initial monomers).

A foam of the present invention was prepared as follows. The superabsorbent polymer was dried in an oven under vacuum, at 60° C. (MA030/12 obtained from Marconi), and diluted with deionized water for a solution containing 10% solids and 90% deionized water (with means diluting 10 grams of the polymer in 90 mL of deionized water in a glass beaker). A premix was made consisting of polyol, additives (surfactant, gel and blow catalysts), and Superabsorbent Polymer diluted solution. The contents were weighed out to the nearest 0.01 grams into a plastic container. The premix was mixed using a mixing apparatus (Foam Mixer WL5700, obtained from IDM Instruments, Victoria, Australia) for approximately 2 minutes at 800 rpm or until the solution was completely homogenous (and the Superabsorbent Polymer was completely dispersed in the polyol matrix). A conventional prepolymer system, consisting of 65% Voranol 3010 and 35% Toluene Diisocyanate was weighed out into a plastic syringe to guarantee accuracy of measurement and total addition of the prepolymer (and smallest residual). Same mixing apparatus described above (Foam Mixer WL5700, obtained from IDM Instruments, Victoria, Australia) was set up in 3.000 rpm and the prepolymer system was added by tightening the syringe to the premix in one continuous move and mixed for about 15 seconds or until blowing started. The foam formulation of the present invention for Example 1 is provided in Table 1.

TABLE 1

| Material | php | Weight (g) |
|---|---|---|
| 65% TDI Voranate T80, 35% | 51.65 | 66.08 |
| Voranol 3010 (Pre-polymer) | | |
| Voranol 3010 (Polyol) | 100 | 127.92 |
| Superabsorbent Polymer (SAP) | 0.60 | 0.88 |
| Water (Blowing agent) | 2.25 | 2.88 |
| Tegostab B 8228 (Silicon surfactant) | 1.00 | 1.28 |
| Dabco BL17 (Blowing catalyst) | 0.10 | 0.13 |
| Dabco DEOA L (Crosslinker) | 0.50 | 0.64 |
| KOSMOS 29 (Tin 2-Ethylhexanoate) (Gel catalyst) | 0.10 | 0.13 |
| Tegoamin AS33 (Gel catalyst) | 0.05 | 0.06 |
| | | 200.00 |

Results for the theoretical water absorption, practical water absorption, capillarity over time, airflow, and density tests for Example 1 and the Comparative Example are reported in Table 2.

TABLE 2

| Test Methods | Example 1 | Comparative Example |
|---|---|---|
| Practical Absorption (%) | 53% | 37% |
| Capillarity over time | Yes | No |
| Airflow (cm³/s) | 2.900 | 1.900 |
| Density (kg/m³) | 15.2 | 21.5 |

As can be seen from the results listed in Table 2, the foam of the present invention (Example 1) has higher practical water absorption compared to the Comparative Foam. Example 1 also had capillarity over time as well as increased airflow, due to more open cells.

### Example 2

A superabsorbent polymer of the present invention was prepared as follows. A solution of potassium acrylate was made by titrating an aqueous solution of potassium carbonate with acrylic acid. Considering stochiometric quantities of the reactants, 276.42 grams of potassium carbonate was dissolved in 1.000 mL of deionized water in an Erlenmeyer beaker, and titrated with 288.24 grams of acrylic acid in a graduated burette. The acrylic acid was added by slow dripping to the potassium carbonate, and the final solution contained in the Erlenmeyer beaker was mixed with a magnetic bar in a stirrer/hot plate from Corning until the reaction ended (and no more carbon dioxide bubbles were seen). A final theoretical solids percentage was of 30.6% (g/g).

Into a 1000 mL four-neck glass reactor was added 100 mL of the potassium acrylate solution prepared, 216 mL of deionized water, and 19.76 grams of acrylamide. The proportion between the acrylamide and the potassium acrylate was that a final theoretical solids percentage was of 15% (g/g). The contents were weighted out to the nearest 0.01 grams into the reactor and mixed using an overhead stirrer (EUROSTAR 60 digital, obtained from IKA), at 35° C. and 120 rpm for 30 minutes or until solution was completely homogenous. After total homogenization, a group of initiators was added (0.20 grams of potassium persulfate, and 0.10 grams of sodium metabisulfite), since reaction was made by free radical polymerization, and the mixer speed was reduced to 100 rpm. No crosslinker was added. When the reaction started (exothermic process), the temperature was raised to 60° C. (maximum of 65° C.) and mixer speed was raised to 150 rpm. The system was mixed using the same mixing apparatus described above (EUROSTAR 60 digital, obtained from IKA) until reaction ended. The final product was a viscous gel with 15% solids g/g (both theoretical and measured, indicating that the total reaction occurred between the initial monomers).

A foam of the present invention was prepared as follows. A premix was made consisting of polyols, additives (surfactant, gel and blow catalysts), and the Superabsorbent Polymer gel solution (without prior treatment, nor drying). The contents were weighed out to the nearest 0.01 grams into a plastic container. The premix was mixed using a mixing apparatus (Foam Mixer WL5700, obtained from IDM Instruments, Victoria, Australia) for approximately two minutes at 800 rpm or until the solution was completely homogenous (and the Superabsorbent Polymer was completely dispersed in the polyol matrix). A conventional prepolymer system, consisting of 65% Voranol 3010 and 35% TDI (Toluene Diisocyanate Voranate, T80 from Dow), was weighed out into a plastic syringe to guarantee the accuracy of measurement and total addition of the prepolymer (and smallest residual). The mixing apparatus (Foam Mixer WL5700, obtained from IDM Instruments, Victoria, Australia) was set up in 3.000 rpm and the prepolymer system was added by tightening the syringe to the premix in one continuous move and mixed for about 15 seconds or until blowing started. The foam formulation of the present invention for Example 2 is provided in Table 3.

TABLE 3

| Material | php | Weight (g) |
|---|---|---|
| 65% TDI Voranate T80, 35% | 110 | 100.31 |
| Voranol 3010 (Pre-polymer) | | |
| Voranol 3010 (Polyol) | 94.50 | 86.25 |
| Voranol 1421 (Polyol) | 5.50 | 5.02 |
| Superabsorbent Polymer (SAP) | 0.88 | 1.11 |
| Water (Blowing agent) | 5.00 | 4.56 |
| Tegostab B 8228 (Silicon surfactant) | 0.75 | 0.68 |
| Dabco BL 17 (Blowing catalyst) | 0.60 | 0.54 |
| Dabco DEOA L (Crosslinker) | 0.50 | 0.45 |
| KOSMOS 29 (Tin 2-Ethylhexanoate) | 0.1275 | 0.11 |
| (Gel catalyst) | | |
| Tegoamin AS33 (Gel catalyst) | 0.05 | 0.04 |
| TEGOCOLOR Yellow (Pigment) | 1.00 | 0.91 |
| | | 200.00 |

Results for the theoretical water absorption, practical water absorption, capillarity over time, airflow, and density tests for Example 2 and the Comparative Example are reported in Table 4.

TABLE 4

| Test Methods | Example 2 | Comparative Example |
|---|---|---|
| Practical Absorption (%) | 75% | 37% |
| Capillarity over time | Yes | No |
| Airflow (cm³/s) | 1.600 | 1.900 |
| Density (kg/m³) | 25.0 | 21.5 |

As can be seen from the results listed in Table 4, the foam of the present invention (Example 2) has higher practical water absorption compared to the comparative sample. Example 2 also has capillarity over time.

The foregoing Examples have been provided for clarity of understanding only, and no unnecessary limitations are to be understood therefrom. The tests and test results described in the Examples are intended to be illustrative rather than predictive, and variations in the testing procedure can be expected to yield different results. All quantitative values in the Examples are understood to be approximate in view of the commonly known tolerances involved in the procedures used.

It will be apparent to those skilled in the art that the specific exemplary elements, structures, features, details, configurations, etc., that are disclosed herein can be modified and/or combined in numerous embodiments. The present invention may suitably comprise, consist of, or consist essentially of, any of the disclosed or recited elements. As used herein, the term “consisting essentially of” does not exclude the presence of additional materials which do not significantly affect the desired characteristics of a given composition or product. In particular, any of the elements that are positively recited in this specification as alternatives, may be explicitly included in the claims or excluded from the claims, in any combination as desired. All such variations and combinations are contemplated by the inventor as being within the bounds of the conceived invention, not merely those representative designs that were chosen to serve as exemplary illustrations. Thus, the scope of the present invention should not be limited to the specific illustrative structures described herein, but rather extends at least to the structures described by the language of the claims, and the equivalents of those structures. To the extent that there is a conflict or discrepancy between this specification as written and the disclosure in any document incorporated by reference herein, this specification as written will control.

What is claimed is:

1. A hydrophilic polyurethane end-capped with a superabsorbent polymer.

2. The hydrophilic polyurethane of claim 1, having a practical water absorption of at least about 40%.

3. The hydrophilic polyurethane of claim 1, wherein the super absorbent polymer comprises:
a first monomer with a reactive group with isocyanate; and
a second monomer having high water absorbency,
wherein the monomers have double bonds.

4. The hydrophilic polyurethane of claim 3, wherein the second monomer is a monomer with a carboxylate group.

5. The hydrophilic polyurethane of claim 3, wherein the first monomer is a monomer having a hydroxy or amine group.

6. The hydrophilic polyurethane of claim 1, wherein the super absorbent polymer comprises:
one of sodium acrylate and potassium acrylate; and
acrylamide.

7. The hydrophilic polyurethane of claim 1, comprising:
polyol;
diisocyanate;
a blowing agent;
a monomer with a reactive group with isocyanate; and
a monomer with a carboxylate group,
wherein the monomers have double bonds.

8. The hydrophilic polyurethane of claim 1, comprising:
polyol;
diisocyanate;
one of potassium acrylate and sodium acrylate;
acrylamide; and
a blowing agent.

9. The hydrophilic polyurethane of claim 1, wherein the polyurethane includes a superabsorbent polymer backbone.

10. A method of forming a polyurethane having a superabsorbent polymer in a backbone of the polyurethane, the method comprising:
providing a pre-polymer having hydrophilic functionality;
mixing the pre-polymer with polyol to form a blend; and
mixing the blend with diisocyanate.

11. The method of claim 10, wherein mixing the pre-polymer with polyol also comprises mixing the pre-polymer with a catalyst, a surfactant, and a blowing agent.

12. The method of claim 10, wherein the polyurethane has a practical water absorption of at least about 40%.

13. The method of claim 10, wherein the superabsorbent polymer comprises:
a monomer with a reactive group with isocyanate; and
a monomer having high water absorbency,
wherein the monomers have double bonds.

14. The method of claim 13, wherein monomer having high water absorbency is a monomer with a carboxylate group.

15. The method of claim 10, wherein the super absorbent polymer comprises:
one of sodium acrylate and potassium acrylate; and
acrylamide.

16. A method of forming a polyurethane foam having a practical water absorption of at least about 40%, the method comprising:
providing a pre-polymer comprising:
a first monomer with a group reactive with isocyanate; and
a second monomer having high water absorbency,
wherein the monomers have double bonds;
mixing the pre-polymer with polyol to form a blend; and
mixing the blend with diisocyanate.

17. The method of claim 16, wherein the second monomer having high water absorbency is a monomer with a carboxylate group.

18. The method of claim 16, wherein the first monomer is a monomer having a hydroxy or amine group.

19. The method of claim 16, wherein the polyurethane has a practical water absorption of at least about 60%.

20. The method of claim 16, wherein the pre-polymer comprises:
one of potassium acrylate and sodium acrylate; and
acrylamide.
